(19) United States
(12) Patent Application Publication
(10) Pub. No.: US 2025/0058946 A1
(43) Pub. Date: Feb. 20, 2025

(54) CLOSURE DEVICES ESPECIALLY ADAPTED TO ENSURE PROPER CLOSURE OF BIOLOGICAL SPECIMEN CONTAINERS AND BIOLOGICAL SPECIMEN COLLECTION KITS INCLUDING THE SAME

(71) Applicant: LUNA LABS USA, LLC, Charlottesville, VA (US)

(72) Inventors: J. David REMER, Charlottesville, VA (US); Kelley Mitchell VIRGILIO, Charlottesville, VA (US); Connor McKECHNIE, Charlottesville, VA (US); Emily CHAK, Charlottesville, VA (US)

(21) Appl. No.: 18/452,433

(22) Filed: Aug. 18, 2023

(51) Int. Cl. B65D 51/24; B65D 51/18

(52) U.S. Cl. CPC B65D 51/248; B65D 51/18; B65D 2203/12; B65D 2251/0028; B65D 2251/009

(57) ABSTRACT

Closure devices and kits allow closure of an open-ended container and provide a visible indication of closure torque. The closure device will include an outer cap defining a torque indicator window, an inner cap nested within the outer cap and a torque indicator post positionally fixed to and extending upwardly from an upper surface of the inner cap in alignment with the indicator window of the outer cap. The outer and inner cap are mechanically coupled to one another such that turning movement applied to the closure device allows the outer and inner caps to be turned as a unit and threadably coupled onto the threaded open-ended container until the inner cap is frictionally engaged with an edge of the container whereupon continued turning movement of the outer cap relative to the inner cap causes coaxial downward displacement of the outer cap relative to the inner cap. Such axial downward displacement thereby causes the indicator post of the inner cap to protrude upwardly through the indicator window of the outer cap thereby indicating sufficient closure torque for the closure device.

### GOVERNMENT RIGHTS

The disclosed embodiments were made with support by the Centers for Disease Control and Prevention (CDC) under Contract Nos. 75D30121P11823 and 75D30121P11823. The Government may have certain rights in the invention.

### FIELD

The embodiments disclosed herein relate generally to closure devices for containers. In especially preferred forms, the embodiments disclosed herein relate to closure devices for reliably closing biological specimen containers which include a visible indicator when sufficient closure torque has been achieved.

### BACKGROUND

Biological specimen containers are critical components of modern healthcare infrastructure. Although specimen containers are relatively low-cost and expendable, they must nonetheless be depended on by health care professionals to reliably transport a wide range of biological specimens, including high-risk samples that may be pathogenic or irreplaceable.

The importance of container integrity is further emphasized due to potential costs associated with containment failure. These costs may be compounded if leakage leads to sample contamination, which may result in false test results or cross-contamination, rendering additional samples useless. Another potential cost of specimen leakage is personnel exposure. As some samples contain noxious or pathogenic contents, there is an increased risk of harm to personnel handling compromised samples.

Multiple reasons exist for these specimen containment failures, though the primary identified failure triggers include human factors and environmental elements. The most significant containment failure is likely due to improper container closure by individuals. This factor was exacerbated in the COVID-19 crisis due to a large number of quickly-trained testing staff who may not apply the correct lid closure torque. The process is difficult even for experienced staff who may have to hold the specimen container, secondary-containment bag, container label, and swab while also performing the nasopharyngeal swab.

Improper lid placement or closure at this stage can cause a failure on its own, or it can be enhanced by environmental conditions during sample transport. Changes in temperature or air pressure (as experienced during ground or air transport) leads to a pressure differential between the container interior and the atmosphere. While the IATA Dangerous Goods Regulations, Packing Instruction 650 requires biological specimen containers to withstand a pressure differential of 95 kPa, improper lid closure can greatly reduce this capability and even result in failure of the specimen container.

In most biospecimen collection clinics, collection containers are sealed using a plastic-on-plastic wiper seal. These collection cups are notorious for leaking and are susceptible to cross threading. Furthermore, there is little regard in these designs for individuals who may lack the wrist strength necessary to properly close these containers. An improperly sealed container poses many issues not just for the patient, but also for the lab technicians who aliquot samples from the biospecimen collection. If the container leaks too much, the lab technician will be unable to collect an adequate amount of biospecimen. The patient will have to return to the clinic and provide another sample. Additional risk to clinical staff is posed by leakage of potentially hazardous materials.

There thus exists a need for a low-cost, positive feedback, closure solution with an integrated, leak-proof gasket for biospecimen collection. It is towards providing such a need that the embodiments disclosed herein are directed.

### SUMMARY

Broadly, the embodiments disclosed herein relate to closure devices which allow closure of an open-ended container and provide a visible indication of closure torque. In preferred embodiments, the closure device will include an outer cap defining a torque indicator window, an inner cap nested within the outer cap and a torque indicator post positionally fixed to an upper surface of the inner cap and capable of being extended through the torque indicator window.

The outer and inner cap are mechanically coupled to one another such that turning movement applied to the closure device allows the outer and inner caps to be turned as a unit and threadably coupled onto the threaded open-ended container until the inner cap is frictionally engaged with an edge of the container whereupon continued turning movement of the outer cap relative to the inner cap causes coaxial downward displacement of the outer cap relative to the inner cap. Such axial downward displacement thereby causes the indicator post of the inner cap to protrude upwardly through the indicator window of the outer cap thereby indicating sufficient closure torque for the closure device.

According to certain embodiments, the inner cap will include a series of angled inner ledge protrusions each having a downwardly and outwardly angled ramp surface while the outer cap includes a lower angled outer ledge protrusion defining an upwardly and inwardly angled ramp surface that is engageable with the downwardly and outwardly angled ramp surfaces of the inner ledge protrusions. Further, the outer cap may include upper grooves, and wherein the inner cap includes angled upper teeth operatively received within the upper grooves of the outer cap. These mechanical interconnections thereby allow the outer cap to be axially displaced relative to the inner cap upon reaching sufficient closure torque for the closure device as briefly described above.

These and other aspects of the present invention will become more clear after careful consideration is given to the following detailed description of a presently preferred exemplary embodiment thereof.

### BRIEF DESCRIPTION OF THE DRAWINGS

Reference will be made to the accompanying drawing Figures, wherein:

FIG. 1 is a perspective view of an exemplary closure device operatively associated with a biological specimen collection container;

FIG. 2 is an exploded top perspective view of the closure device components depicted in FIG. 1;

FIG. 3 is an exploded bottom perspective view of the closure device components depicted in FIG. 1;

FIG. 4 is a partial cross-sectional perspective view of the closure device shown in a state of insufficient closure torque; and

FIG. 5 is a partial cross-sectional perspective view of the closure device shown in a state of sufficient closure torque.

### DETAILED DESCRIPTION

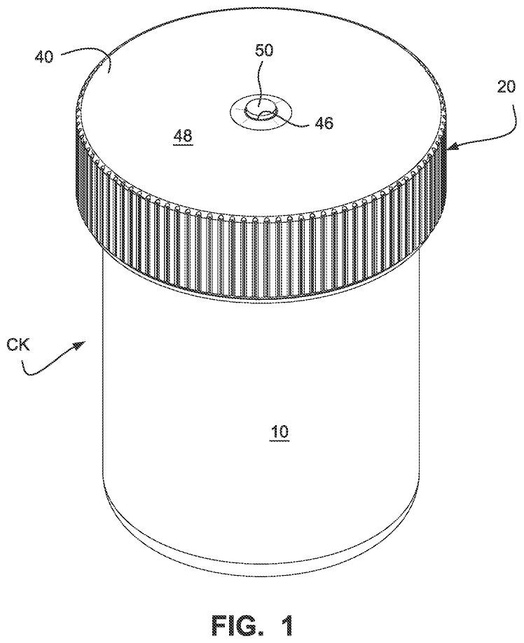

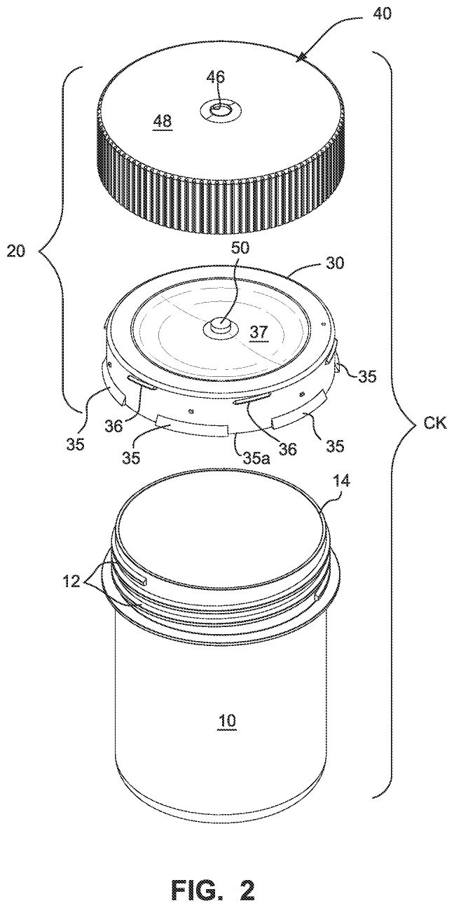

Accompanying FIGS. 1-3 show a specimen collection kit CK in accordance with an embodiment of the present invention which is comprised generally of a specimen container 10 and a closure device 20 comprised of an inner cap 30 nested within an outer cap 40.

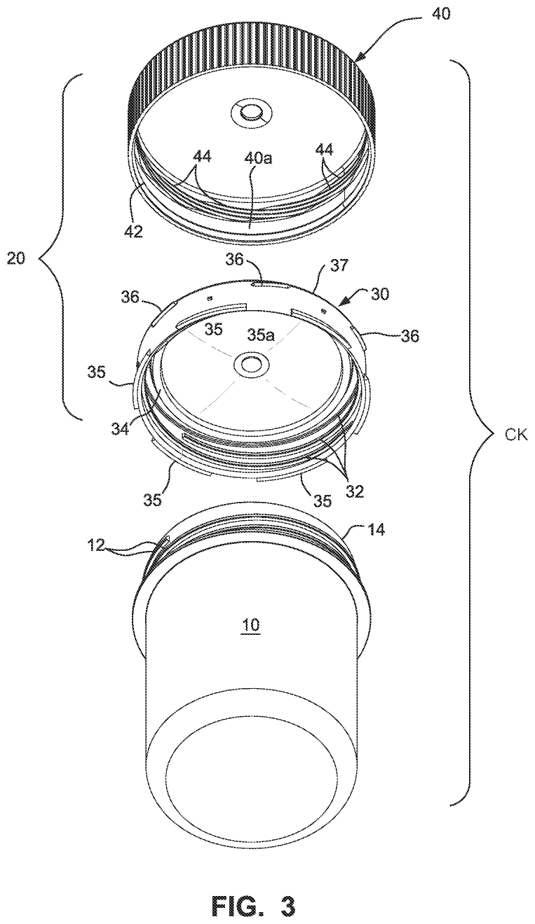

The specimen container 10 is in and of itself an open-ended container of sufficient size and volume so as to receive and contain the desired amount of collected biological material. The upper exterior surface region of the open-ended container 10 will therefore be provided with conventional right-hand external threads 12 that cooperate with the right-hand internal threads 32 of the inner cap 30 to thereby allow the latter to be threadably connected to the former in response to a clockwise turning movement. An annular pressure-sensitive gasket 34 (see FIG. 3) formed of a suitable elastomeric material inert to the biological specimen is received within the inner cap 30 so as to contact the upper edge 14 defining the upper open end of the container 10 and establish a liquid-tight seal when the closure device 20 has been threadably tightened onto the container 10 with sufficient torque. The gasket 34 may be a separate component which is fixed (e.g., via adhesive) to the inner cap 30 or may be over-molded with the inner cap 30 during production.

The inner cap 30 is provided with a series of ledge protrusions 35 having downwardly and outwardly angled ramp surfaces circumferentially spaced apart along the lower edge 35a and a series of angled teeth 36 positioned near the upper surface 37 thereof. The outer cap 40 includes a lower angled ledge protrusion 42 defining an upwardly and inwardly angled ramp surface which is engageable with the ramp surfaces of the angled ledge protrusions 35 of the inner cap 30. Inclined upper grooves 44 (see FIG. 3) are provided along the upper interior surface 40a of the outer cap 40 which are sized and configured to receive the angled upper teeth 36 of the inner cap 30 therein.

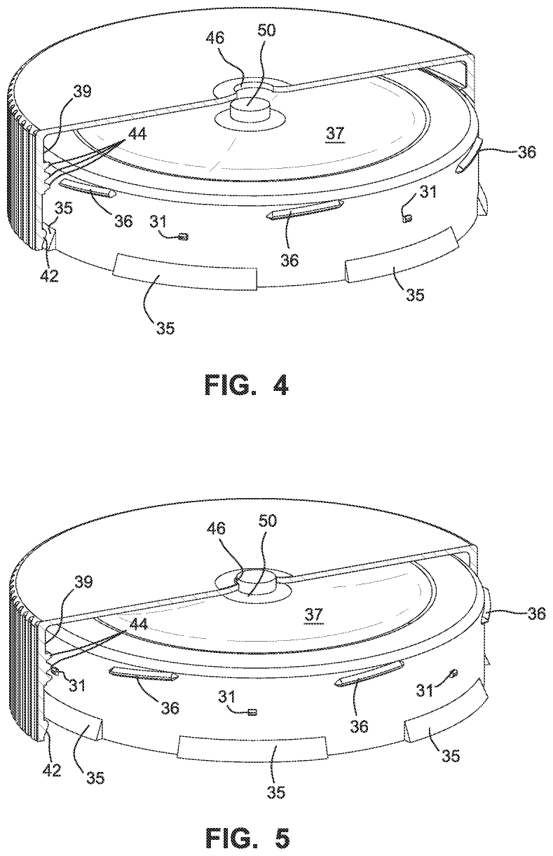

As is perhaps more clearly shown in FIGS. 4 and 5, the interconnected inclined upper grooves 44 of the outer cap 40 and the angled upper teeth 36 of the inner cap 30 will in use allow the inner and outer caps 30, 40, respectively, to be rotated as a unit to allow the internal threads of the inner cap 30 to be threadably engaged with the external threads 12 of the container upon clockwise turning movement being applied to the closure device 20. A friction force will thus ultimately be encountered when the upper edge 14 engages the gasket 34 within the inner cap 30. Such a friction force will thereby substantially arrest continued turning movement of the inner cap 30 relative to the container 10. The outer cap 40 however is capable of continued clockwise turning movement so as to apply additional torque to the inner cap 30 due to the engagement between the angled upper grooves 44 and the angled teeth 36 received therein.

The continued turning movement of the outer cap 40 will cause the angled teeth 36 to generate a downward force against the angled upper grooves 44. The resultant downward force causes the engaged conformably configured ramp surfaces of the angled ledge protrusions 35 and 42 to engage one another. Upon generation of sufficient downward force via the interaction of the angled teeth 36 and the angled upper groovers 44, the outer cap ledge protrusion 42 rapidly slips over the inner cap ledge protrusion 35, resulting in a downward translation of the outer cap 40 as well as an audible and tactile indication of closure. At this time, the angled teeth 36 are positioned within the annular upper groove 39 of the inner cap and are thus disengaged from the angled upper grooves 44. In such a state, the outer cap 40 will then be capable of free rotation relative to the inner cap 30 thereby providing a tactile indication that the closure device 20 has been properly torqued onto the container 10.

In order to remove the closure device 20 from the container 10, a user needs to apply opposing radial pressure onto the outer cap 40. Such radial pressure thereby brings the angled teeth 36 into engaged with the radial extensions 31 of the inner cap 30 at which time the inner and outer caps 30, 40, respectively, may be turned as a unit in a counterclockwise direction so as to remove the closure device 20 from the container 10.

A visible torque indicator post 50 is preferably positionally fixed to the center of the upper surface 37 of the inner cap 30 so as to axially protrude upwardly therefrom and be coaxially aligned with the indicator window 46 formed in the upper surface 48 of the outer cap 40. The indicator window 46 is sized and configured so as to allow the indicator post 50 to extend therethrough. The indicator post 50 is in turn sized and configured such that during threaded coupling of the closure device 20 onto the container 10, the upper terminal end of the indicator post 50 does not extend through the indicator window 46 beyond the upper surface 48 of the outer cap 40 as shown in FIG. 4. However, when sufficient torque has been applied to the closure device to ensure a fluid tight seal between the upper edge 14 of the container 10 and the seal gasket 34, i.e., a state whereby the outer cap 40 has been axially displaced toward the inner cap 30 so the latter is capable of being turned freely relative to the former, the indicator post 50 will be caused to extend through the indicator window 46 so as to be visibly apparent. Such a state is shown in FIG. 5. Extension of the indicator post 50 in such a manner thereby provides visible confirmation that sufficient torque has been applied to the closure device. The indicator post may be provided with a readily identifiable color so as to further enhance its visibility when extended through the indicator window 46.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope thereof.

What is claimed is:

1. A closure device to allow closure of an open-ended threaded container and provide a visible indication of sufficient closure torque, the closure device comprising:
an outer cap defining a torque indicator window;
an inner cap nested within the outer cap; and
a torque indicator post positionally fixed to and extending upwardly from an upper surface of the inner cap in alignment with the indicator window of the outer cap, wherein
the outer and inner cap are mechanically coupled to one another such that turning movement applied to the closure device allows the outer and inner caps to be turned as a unit and threadably coupled onto the threaded open-ended container until the inner cap is frictionally engaged with an edge of the container whereupon continued turning movement of the outer cap relative to the inner cap causes coaxial downward displacement of the outer cap relative to the inner cap to thereby cause the indicator post of the inner cap to protrude upwardly through the indicator window of the outer cap thereby indicating sufficient closure torque for the closure device.

2. The closure device according to claim 1, wherein
the inner cap includes a series of angled inner ledge protrusions each having a downwardly and outwardly angled ramp surface; and wherein
the outer cap includes a lower angled outer ledge protrusion defining an upwardly and inwardly angled ramp surface that is engageable with the downwardly and outwardly angled ramp surfaces of the inner ledge protrusions.

3. The closure device according to claim 2, wherein the outer cap includes upper grooves, and wherein the inner cap includes angled upper teeth operatively received within the upper grooves of the outer cap.

4. The closure device according to claim 1, wherein the closure device comprises an annular sealing gasket positioned on an interior surface of the inner cap.

5. The closure device according to claim 4, wherein the sealing gasket is over-molded onto the interior surface of the inner cap.

6. The closure device according to claim 1, wherein the indicator window and indicator post are coaxially aligned with one another along a central axis of the closure device.

7. The closure device according to claim 6, wherein the indicator post is colored.

8. A specimen collection method comprising the steps of:
(a) collecting a specimen within a threaded open-ended container; and
(b) closing the open-ended container by threadably coupling the closure device according to claim 1 to the container until an indication of sufficient closure torque is visible by the indicator post protruding through the torque indicator window.

9. The method according to claim 9, wherein the specimen is a biological specimen.

10. A specimen collection kit comprising:
an open-ended threaded container, and the closure device according to claim 1.

11. The specimen collection kit according to claim 11, wherein
the inner cap includes a series of angled inner ledge protrusions each having a downwardly and outwardly angled ramp surface; and wherein
the outer cap includes a lower angled outer ledge protrusion defining an upwardly and inwardly angled ramp surface that is engageable with the downwardly and outwardly angled ramp surfaces of the inner ledge protrusions.

12. The specimen collection kit according to claim 12, wherein
the outer cap includes upper grooves, and wherein
the inner cap includes angled upper teeth operatively received within the upper grooves of the outer cap.

13. The specimen collection kit according to claim 11, wherein the closure device comprises an annular sealing gasket positioned on an interior surface of the inner cap.

14. The specimen collection kit according to claim 14, wherein the sealing gasket is over-molded onto the interior surface of the inner cap.
